(19) United States
(12) Patent Application Publication
(10) Pub. No.: US 2013/0224041 A1
(43) Pub. Date: Aug. 29, 2013

(54) Horizontal Wind Power Turbine

(71) Applicant: Romeo Prasad, Windsor, CT (US)

(72) Inventor: Romeo Prasad, Windsor, CT (US)

(21) Appl. No.: 13/711,579

(22) Filed: Dec. 11, 2012

Related U.S. Application Data
(60) Provisional application No. 61/630,885, filed on Dec. 22, 2011.

(51) Int. Cl. F03D 11/04

(52) U.S. Cl. CPC F03D 11/04
USPC 416/244 R

(57) ABSTRACT

A new improved wind Power Turbine with rotors that are mounted for rotation about a central axle also a funnel shape inlet is present at the smaller ends of said passages. It delivers the air at high velocities towards the rotor. In addition a rotor shield is fixed on the right side of the turbine so as to isolate the rotor's reverse side from incoming wind. The central axle upper/lower bearing rotates in lubricated cups. Also an rectangle exhaust connect to a larger rectangle exhaust system where as air passage fixed with a sudden wider rectangle opening causes the exhaust air to evaporate. The central axle's upper and lower bearing is housed in a insulated area to prevent bearings from freezing.

### CROSS-REFERENCE TO PRIORITY APPLICATION

This application claims the benefit of Provisional U.S. application Ser. No. 61/630,885 filed Dec. 22, 2011 by inventor Romeo Prasad. Address P.O. Box 1982, Hartford Conn. 06144

### FIELD OF THE INVENTION

This invention relates to horizontal rotation wind turbine of the type in which the upper and lower insulated platform is present, a rotor is fixed on a vertical axle and in which a funnel shape inlet are disposed on the left side of the rotor to direct the air flow into the turbine central body and an rectangle exhaust fixed to a larger rectangle exhaust system which causes the exiting wind to moves more freely.

### ABSTRACT OF THE DISCLOSURE

A new improved wind Power Turbine with rotors mounted for rotation about a central axle, a funnel shape inlet is presented the smaller ends of said passages been position to deliver the air at high velocities towards the rotor. A rotor shield is fixed on the right side of the turbine for isolate the rotor reverse side from incoming wind, the central axle upper/lower bearing rotates in lubrication cups. An exhaust system in which the inside a rectangle air passage fixed with a sudden wider rectangle opening causes the exhaust air to evaporate. The central axle upper and lower bearing is housed in insulated area to prevent bearings from frozen.

### SUMMARY OF THE INVENTION

The present invention in its broadest aspect relates to a horizontal axis wind turbine which includes a upper base, a lower base, a central body comprises of a rotor, a vertical axle extended upwardly from the lower base to the upper base, a rotor is fixed on an axle, a wind direction tail vane for directing the rotor in the direction to on-coming wind and a turntable.

According to one aspect of the present invention provides a horizontal axle wind turbine, the rotor is formed by five or more vertical blades members secure on a round cylinder by securement means. The vertical rotor blades receiving edge is such that the sharp edge of the blade is adept to catch the wind and each rotor are equidistantly space from one another.

According to another aspect of the present invention a wind turbine comprise of a funnel shape inlet that the air passes through such a funnel shape to accelerate and direct the incoming air flow forcing the wind to increases its velocity. This feature is particularly important it increases the rotor rotation.

According to another aspect of the present invention a wind turbine comprised of a funnel shape inlet, the upper end cap overlapping the lower end cap, to form a complete shelter about the rotor to protect the rotor from difficult weather conditions such as hail, snow and rain. This future is particularly important. Forming a complete shelter means snow and hail cannot acuminate and obstruct incoming air flow which can slow rotator rotation.

According to another aspect of the present invention a wind power turbine the exhaust system with angle walls around the outside for channeling the wind, means steers the outside air flow from making direct contact with rotor exiting wind, thereof to create a greater rotational force about the rotor shaft.

According to another aspect of the present invention a wind power turbine exhaust structure is provide the upper end plate overlapping the lower end plate to form a complete shelter about the rotor. To protect the turbine exhaust system from difficult weather conditions such as hail and snow.

According to another aspect of the present invention a wind power turbine, the exhaust system form of a rectangle connected to a larger rectangle, this sudden wider rectangle area causing the exiting wind to loosen its pressure, thereof to create a greater rotation force about the rotor.

According to another aspect of the present invention a wind power turbine whereby the incoming air flow is directed through the inlet for rotation about the rotor, this airflow path exits in the rear end. On the reverse side about the rotor a certain amount of drag will be creating between the back inner or outer semi curve wall and well known in art. Air vents can be arrange on the inner back wall which direct the air to the exhaust chute which would serves to reduce air drag and make the system more efficient.

According to another aspect of the present invention a wind power turbine a rotor mounted on a support member for rotation about the central axis. On the opposite side a inner and outer curve wall is fixed for isolate the right side of the central body and the rotor reverse side from incoming wind. The Inner curve wall is essential but not important only an optional future.

According to another aspect of the present invention, a wind power turbine of the type which a rotor is mounted on a vertical axle. The axle is journal with upper and lower bearings, at the lower end of the axle a bearing fixed in a liquid /fluid cup for bearing lubrication, this requirement causes the bearing to rotates in liquid/fluid without a seal. Another embodiment the axle upper bearing is attached to a central hub inside the upper platform for rotation. A cup with liquid/fluid is fastened on the axle and rotates with the axles which are adapted for bearing lubrication. This is the key to this invention, is how the central axle upper and lower seal-less bearing is lubricated for rotation.

According to another aspect of the present invention, provide a wind power turbine whereas the upper and lower platform attached to a central body, the lower platform act as a base for the rotor central body. The upper and lower platform inside wall is approximately 99.99% insulated form, are adapted to keep all mechanical parts in the upper and lower platform operating in frigid cold weather and hot weather.

According to another aspect of the present invention a wind power turbine central body, a tail vane or double tail vane can be arrange on the rear above the exhaust system or manual setup can be arrange which point or automatically point the turbine inlet to proper wind direction to receive the wind that blows on the turbine.

According to another aspect of the present invention provide a wind power turbine whereas the upper and lower platform wall, is approximately 100 percent water resistance means rain cannot gain access which can cause malfunction.

### BRIEF DESCRIPTION OF FIGURE

FIG. 1 is a perspective view of an embodiment of an improved wind turbine system.

FIG. 2 is a perspective of an embodiment of an improved wind turbine rotor arrangement with intake, exhaust and side shield.

FIG. 3 is a perspective of an embodiment of an improved wind turbine exhaust system.

FIG. 4 is a perspective of an embodiment of an improved wind power turbine intake system.

### DETAILED DESCRIPTION

In essence wind turbines failed to work in cold weather and more particularly frigid cold weather, causing the bearings and other mechanical parts to malfunction, special hydraulic fluid/liquid were designed for cold temperatures was used in wind turbines, but it was a complete failure. Some companies decided to use heaters that will work with electricity or natural gas to keep the temperatures inside the turbine warmer in frigid cold weather, the system did work, however that drastically reduce the net energy gained from each turbines. The present invention relates to a wind turbine that can work in extreme hot or frigid cold weather whereas others wind turbine failed to function.

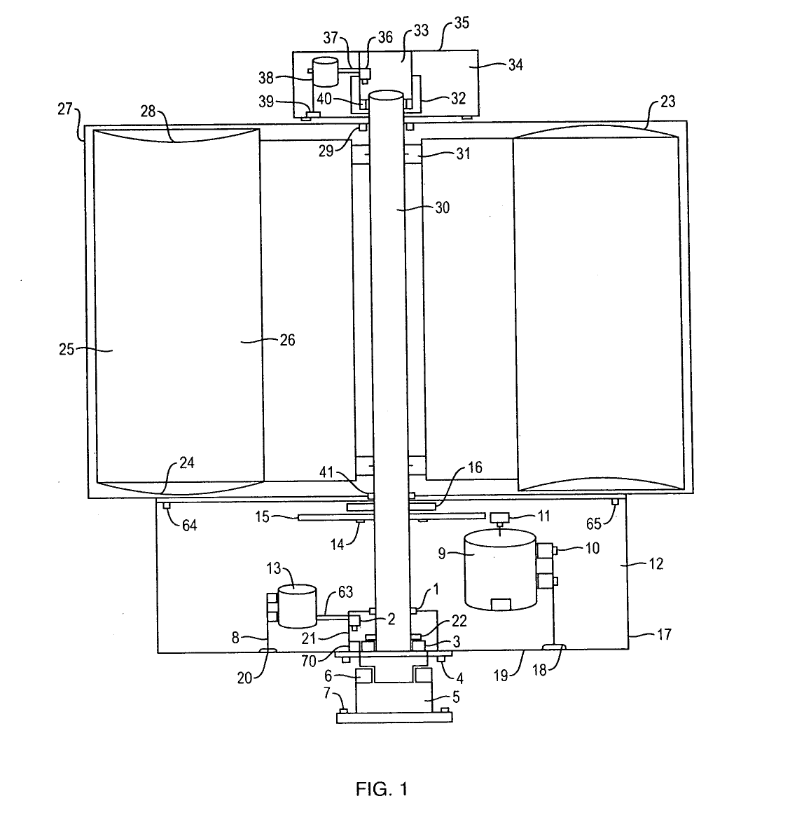

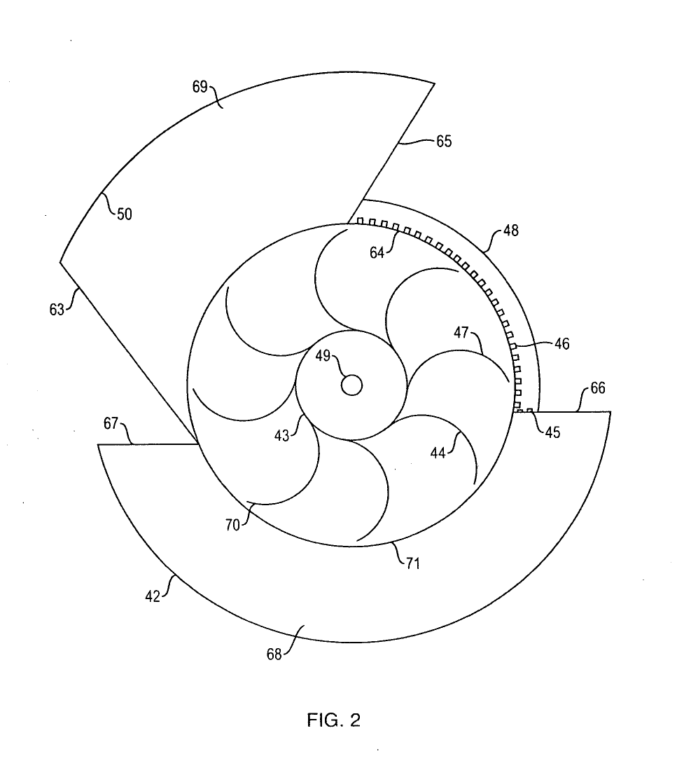

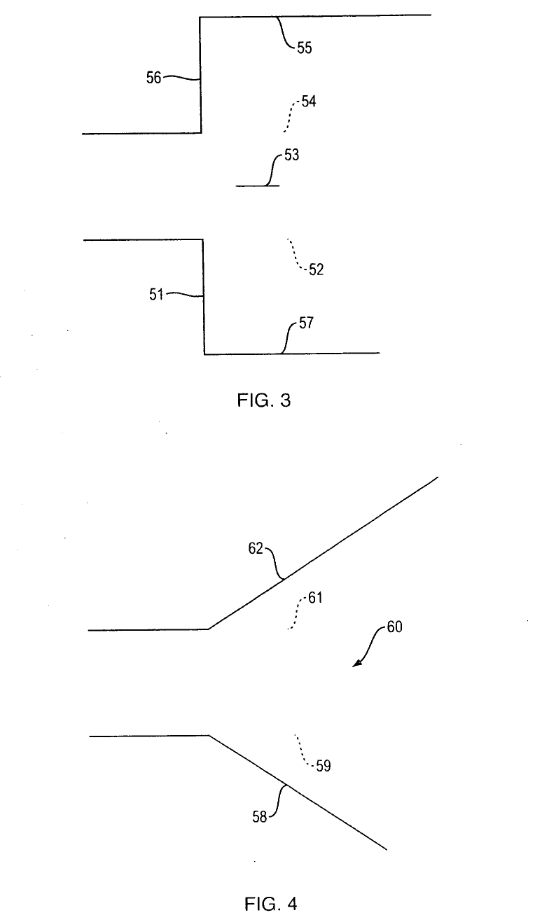

Referring now to the drawings and more particularly to FIGS. 1, 2, 3 and 4. A preferred embodiment of a wind turbine comprises of a vertical rotor 26 for horizontal rotation about a central axis 30 with respect to a support member 5. Each Rotor 28 half round in configuration includes a semi-circular upper and lower end cap 23 and 24 an optional option or can connected to a upper and lower round plate acting as upper and lower end cap in configuration not shown, a plurality of vertical horizontal rotation blades 44 being disposed symmetrically on a round cylinder 43 for rotation about a central axle 30. Each vertical blade 26 is provided with half round buckets extending vertically for horizontal rotation about a central axle 49 which creates a pushing force about a round cylinder 43. The round cylinder 43 is fixed on the central axle 30 and the rotor 44 receiving edge 70 sharply pointed, is such that the sharp edge 70 of the blade is adapted to catch the wind to provide a better aerodynamic and the inner edge is interconnected to a vertical round cylinder 43 for rotation about the central axle 30.

The inlet 69 lies on the left side of the wind turbine central body 27 from the front facing the wind at point dead center of the circumference and extended to the left more than 130 degrees but less than 180 degrees. The inlet 69 mouth is form of an rectangle with two vertical and two semi-circle receiving edges, the top and bottom plate 62 and S8 receiving edges form of a semi-circle SO of a circumference, the lower plate S8 semi-circle receiving edge not shown in drawing, the 2 vertical receiving walls 63 and 6S. The left side vertical wall 63 is tapered to the left and the right side vertical wall 6S is tapered to the right to form a rectangle cone. All four receiving edges sharply pointed into the incoming winds which adopted to catch the wind and provided a better aerodynamic. The inlet 69 is form of a funnel shape, the larger end of the funnel is set on the outside, such a funnel shape is to captured more wind and forcing the wind to increase its velocity as the wind enters through the inlet mouth to the central body and pushes the rotor 70 inner semi-circle or bucket 44 for rotation about the central axle 30 which provide more efficiency and the rotor 70 increases rotation, this air flow path pushes the rotor 44 for rotation and exits the rear S3. The inlet 69 top plate 62 receiving edge SO is form of a semi-circle of a circumference overlapping the bottom plate S8 receiving edge not shown in diagram, which form a complete shield about the rotor 70 to protect the rotor 70 from difficult weather conditions such as rain, hail and snow which can cause the rotor 70 to malfunction and loose efficiency and in some cases, the rotator 70 can stop rotating.

The rotor shield 48 is form of a semi-circle of a circumference fixed on the central body 27 circumferences from front point dead center and extending towards the right to the exhaust chute 4S, act as to isolate the rotor 70 reverse sides 47 from making contact with incoming winds, which causes the rotor 70 to rotates more freely and faster. The inner wall 64 is an optional feature fixed on the inside of the outer wall 48 with spaces between, the two rotor-walls. As the rotor 70 rotates about the central axle 30 for rotation, on the opposite side of the inlet 64 a certain amount of drag would be creating from the rotor 44 reverse side 47 and the back wall 64 air vents 46 releases the backup air pressure and steers the wind to the exit chute 4S which would eliminates almost all the drag created from the rotor 47 reverse side and the back wall 64.

According to an embodiment of the present invention, the exhaust system is fixed on the central body 27 rear and is form of a rectangle connected into a larger rectangle, the exhaust front portion, top and bottom plate 55/57 is form of an inner semi-circle adapted to the same circumference of the central body 71 for fixed connection, as the wind passes through the exhaust system from a smaller rectangular area to a larger rectangular area, this sudden wider area 52/54 causing the exiting wind to loosen its pressure which causes the wind to exiting the central body 27 faster causes the rotor 44 to improve rotation. Another embodiment the exhaust exterior is designed in such a way, to steers the wind around the exhaust exterior away and preventing the outside wind from making direct contact with wind that exiting the central body 27, which would improve rotor rotation. The exhaust 68, top plate outer end semi-circle 42 overlapping the lower plate outer end semi-circle, to form a complete shelter about the rotor 70. To protect the rotor 70 from difficult weather conditions such as snow, hail and rain.

The central axle 30 is journal with upper and lower bearings 40 and 32 for rotation about a central body 27. The lower platform 17 bearing 3 is fixed means immovably inside a hub 70 and the hub 70 fixed inside a lubrication cup 21 for bearing 3 lubrication, the central axle 30 lower end fixed inside bearing 3 immovable with set crews to lock in place. The lower platform 17 a dust cap 1 is fixed on the central axle covering the insulating cup 21 but not touching the cup 21 for preventing dust and other debris from going in the lubricating cup 21 which can cause bearing 3 malfunction. The upper bearing 40 fixed on the upper platform 34 central location inside a hub 32, the upper bearing 40 set with slide fitting movements on the central axle 30 for climate change, in hot weather expansion will occurs to a degree and in cold weather shrinking will occur to a degree, which can causes the central body 27 top and bottom face to expand in hot weather or shrink in cold weather which can causes the bearings 3/40 to seize and the rotor 70 about the central axle 30 can stall, but in this form of upper bearing 40 slide fitting movement on the central axle 30 will prevent bearing seizure and the rotor 70 from stalling in extreme hot or frigid cold weather. A lubrication cup 32 with un-freezable liquid or fluid is fastened and rotates with the central axle 30, covering the upper bearing 40 for bearing lubrication. This new designed is the key to this invention is how the upper seal-less bearing 40 is lubricated and lower seal-less bearings 3 fix in a stationary lubricated cup 21 for lubrication. The central axle 30 lower end a gear 15 is provided for engagement the generator or alternator assembly 9 pulley 11 also chains and sprocket and direct drive can be arrange, for rotation means generate power to charge batteries or an inverter can be added to supply power to power lines 9 not shown in diagram.

As illustrated in FIG. 1, the central body 27 is adapted by upper platform and lower platform 35 and 17. The lower platform 17 act as the base for the turbine, both platform 35 and 17 inside wall is approximately 99.99 percent insulated and approximately 100 percent waterproof from rain and also preventing salt air to a degree from gaining access in the upper and lower platform 17/35, salt air usually doctorate metals. Extreme cold temperatures are the leading cost of failure in almost any types of mechanical equipment. In reference the insulation inside the upper and lower platform 35 and 17 whereas to keep the temperature inside warmer when the outside is frigid cold and cooler when the outside temperature is extreme hot whereas to keep all mechanical parts working. Almost all the mechanical and moving parts are fixed in the upper and lower platform 37 and 17.

What claim is:

1. A wind power turbine comprised of rotor blades connected to a round cylinder, a upper and lower insulated platform interconnected, by a central body, a vertical axle centered from the lower platform to the upper platform, a funnel shape inlet, a rectangle exhaust system fixed to a larger rectangle exhaust system, a perpendicular shield and a tail vane.

2. A improved wind turbine according to claim 1, the rotor is isolated from rain, snow and hail which can caused the rotor to malfunction.

3. A improved turbine system according to claim 1, a rectangle exhaust connect to a larger rectangle means the exiting moves from a normal rectangle to a sudden wider area causing the wind to loosen its pressure creating a faster wind exiting.

4. A improved wind power turbine according to claim 1, the upper and lower platform inside wall is approximately 99.99 insulated and approximately 100 percent water resistance so as to keep to keep the inside temperature warmer when the outside temperature is frigid cold and cooler when the outside temperature is extremely hot.

5. A improved wind power turbine according to claim 1, the vertical axle lower seal-less bearing fixed in a insulated stationary cup whereas for bearing lubrication.

6. A improved wind power turbine according to claim 1, the vertical axle upper seal-less bearing, a insulated cup fixed and rotates with the axle for lubricate the bearing.

7. A improved wind power turbine according to claims 5 and 6, the insulated cups storing liquid or hydraulic fluid that cannot freeze for bearing lubrication.

8. A improved wind power turbine according to claim 7, designed to work in frigid cold or extremely hot weather.

9. A improved wind power turbine according to claim 1, a tail vane can be an optional feature for orientating the inlet into the winds.

10. A improved wind power turbine according to claim 9, a tail vane fixed above the exhaust to isolate itself from exiting winds.

11. A improve wind turbine according to claim 1, the turn table can be an optional future.

12. A improved wind turbine according to claim 1, the generator assembly can be driven by belts, pulleys, gears, chains, sprocket and direct drive.

13. A improved wind turbine according to claim 12, the generator can be insulated whereas for further temperature control.

14. A improved wind power turbine according to claim 1, the upper and lower platform insulated cup and fluid valve can be an optional feature. Control valve is to keep fluid/liquid at an assigned level.

15. A improved wind power turbine according to claim, rotor top and bottom fin can be an option.

16. A improved wind power turbine according to claim 1, rotor upper and lower round cap can be an optional feature.

17. A improved wind turbine according to claim 1, the upper and lower platform central axle seal can be an optional feature.

18. A improved wind power turbine the intake mouth top plate overlapping the bottom plate for preventing the rotor from snow, hail, sleet and rain.

19. A improved wind power turbine exhaust top plate overlapping the bottom plate for preventing the rotor from snow, hail and rain.

20. A improved wind turbine according to claim 1, the central axle upper and lower bearing are seal-less.

21. A improved wind turbine according to claim 1, the central axle upper and lower bearing is lubricated with liquid/fluid that will not freeze.

22. A improved wind power turbine according to claim 1, a wind turbine the longer the length and larger the circumference can increase the energy gain.

23. A improved wind power turbine according to claim 1 the exhaust exterior is designed in a way to steer the outside wind around the exhaust away for preventing exiting wind from making direct contact with outside wind means to improve rotor rotation.

24. A improved wind power turbine according to claim 1, the upper bearing slide fits the vertical axle for preventing bearing seizure in hot or cold temperature.
